(19) United States
(12) Patent Application Publication
(10) Pub. No.: US 2002/0039349 A1
(43) Pub. Date: Apr. 4, 2002

(54) Telecommunications traffic regulator

(76) Inventors: Robert Anderson Malaney, East Killara (AU); Terence Michael Paul Percival, Lane Cove (AU); Peter Glynn Rogers, Beecroft (AU)

Correspondence Address: MERCHANT & GOULD PC, P.O. BOX 2903, MINNEAPOLIS, MN, 55402-0903, US

(21) Appl. No.: 09/844,477

(22) Filed: Apr. 27, 2001

(30) Foreign Application Priority Data
Apr. 27, 2000 (AU) PQ7125

(51) Int. Cl. G01R 11/00

(52) U.S. Cl. 370/230.1

(57) ABSTRACT

A packet traffic shaper (208) is disclosed, comprising determination means (404) configured to determine a constraint parameter dependent upon a probability density function, and constraining means (410, 400) configured to constrain, based upon the parameter, transmission of traffic input to said constraining means (410, 400), thereby to produce output traffic having a pre-determined entropy bound.

### TECHNICAL FIELD OF THE INVENTION

The present invention relates generally to the field of telecommunications traffic management, particularly in the context of packet networks. The invention relates to a method, an apparatus, a computer readable memory medium and a computer program for shaping and policing packet traffic, and also for performing connection admission control, and dynamic bandwidth management of packet traffic.

### BACKGROUND

High speed digital networks that can integrate different sources of traffic are rapidly becoming the foundation of telecommunications. A fundamental requirement of such telecommunications networks is the capability to provide a user of a network with predictable performance levels. In the present Public Switched Telephone Network (PSTN), the science of dimensioning, which is used to achieve a specified Quality of Service (QoS), is a mature discipline. The art of PSTN traffic forecasting is also well developed. The combination of traffic forecasting and network dimensioning enables network service providers to provide PSTN users with predictable performance at an acceptable cost. The aforementioned PSTN design capabilities are scalable, and thus useful as the networks grow to meet user demand.

The ability to provide predictable QoS in modem high speed packet networks, however, is imprecise and is still largely a research topic. This is because such integrated digital networks carry stochastic traffic whose characterising attributes are not as well understood as the corresponding attributes of PSTN traffic.

A number of terms are used throughout this description, and for clarity these terms are now defined.

A “packet” is a unit of information, of fixed or variable length, carried by a network. A “multiplexer” is a network element with a plurality of inputs, and typically a single output. The multiplexer typically has an input packet buffer, and uses a First-in First-out (FIFO) scheduler for allocating connections from each input to the output on a packet by packet basis. A variety of scheduling algorithms can be used to allocate capacity among the users. In general, multiplexers can have more than one output. A “switch” is a network element with a number of incoming links, the switch function being to switch traffic from each of a number of sessions to a correct outgoing links. A switch can, in general, contain one or more multiplexers.

A “shaper” is a device having an input and an output, and containing a packet buffer. The shaper can vary the delay of packets passing through it, and accordingly, the traffic output from a shaper can be constrained to meet specified criteria such as peak packet rate, sustained packet rate and/or average packet rate. A “policer” is a device having an input and an output. The policer can discard packets which would make its output traffic exceed a specified packet rate over a specified time. Alternatively, instead of discarding excess packets, the policer can mark these packets as “non-conforming”, this enabling marked packets to be identified and discarded by other downstream network devices if required. A “regulator” is a device with an input and an output, and it can perform as either a “policer”, or a “shaper”, or both.

In order to appreciate the problems encountered in providing guaranteed QoS in packet networks, a traditional approach using a Token Bucket Regulator (TBR) is first described.

FIG. 1 shows a terminal 100 connected by a transmission path 102 to an edge switch 104 in a network 106. The terminal 100 can, for example, be a boundary router in a business enterprise network, the router being used to connect corporate users on a corporate Local Area Network (LAN) to a public network. The edge switch 104 is connected, as depicted by a dashed line 108 symbolising one or more tandem transmission paths, to an edge switch 110. This edge switch 110 is connected by a transmission path 112 to a second network 114, and thereafter by a transmission path 116 to a terminal 118. The terms “transmission path”, “connection” , “link” and and “line” are used interchangeably in the description.

Users (not shown) of terminals 100 and 118 are typically interested in achieving a predictable QoS from end-to-end, as depicted by an arrow 128. The end-to-end QoS 128 is composed of individual per-network QoSs 124 and 126. The per-network QoS 124 is for example in turn composed of a series of inter-switch QoSs 120, . . . , 122 and so on. Accordingly, FIG. 1 shows how the end-to-end QoS 128, which is of interest to the users of end terminals 100 and 118, is composed of a plurality of tandem QoSs. The aforementioned QoS model applies equally to circuit switched networks such as the PSTN, and to packet networks. Important QoS parameters in packet networks include packet loss, end to end packet delay and end to end packet timing jitter caused by delays and/or overflows in finite buffers in the various network elements (eg. 104, . . . , 110) between the two users.

FIG. 2 shows the terminal 100 and the edge switch 104 in more detail for the case of a packet network. For simplicity the terminal 100 (ie. the boundary router referred to in relation to FIG. 1) is assumed to contain only one multiplexer 204 and one output 102. Each incoming traffic source on corresponding lines 200-202 is regulated in a corresponding regulator 208, the sources thereafter being aggregated in a buffer/FIFO scheduler 209 which forms a front end of a multiplexer 204. The multiplexer 204 outputs a regulated traffic stream on the transmission path 102 which connects across a boundary of the network 106 to the edge switch 104.

A number of traffic sources on corresponding lines 216-218 are similarly input to a terminal 214, which produces regulated traffic on a transmission path 220. The switch 104 can perform a switching function alone, or alternatively, can in addition perform regulation/aggregation functions similar to those which have been described in relation to the terminals 100 and 214. In this latter case, the switch outputs a regulated traffic stream on the connection 108. Accordingly, the FIG. 2 shows how a plurality of traffic sources on corresponding lines 200-202, 216-218 are successively aggregated and regulated in a tandem series of regulating “devices” 100, 214, 104.

FIG. 3 shows an exemplary instance in which the regulator 208 depicted in FIG. 2 is a prior art Token Bucket Regulator (TBR), typically used in traditional fixed length packet networks such as Asynchronous Transfer Mode (ATM), which is capable of acting as a shaper, The TBR 208 has an input traffic stream on the transmission path 200, and produces a regulated output traffic stream on the transmission path 222.

The token bucket regulator 208 has a FIFO buffer 300, and a switch 302 for allowing transmission of bits from the buffer 300 to the output line 222. The occupancy of the buffer 300 is denoted by an arrow 312. The switch 302 is controlled by a Token Bucket regulation process 313 (which is represented conceptually a token “bucket” 306). The process 313 has associated input variables, namely a token bucket size σ which is depicted by an arrow 310, and a token input rate ρ which is depicted by an arrow 308. The regulation process 313 has an output (functioning as a control line) 304. Tokens are provided at an input rate 308 and are continually put into the bucket 306 which has the size σ. Each token which is present in the bucket corresponds to a conceptual “permission” for the regulator 208 to transmit a packet on the line 222. The bucket 306 itself has the specified capacity 310. If the bucket 306 fills to this capacity 310, then newly arriving tokens (not shown) at the bucket 306 are discarded.

When transmitting packets, the regulator 209 must remove from the bucket 306 a number of tokens corresponding to the number of packets transmitted. If there are no tokens in the bucket 306, no packets can be sent. A packet waits in the buffer 300 until the bucket 306 receives a token. Therefore the largest burst a source can send on the line 200, and therefore into the network on the line 222, is defined by the size of the bucket σ ie 306. TBR operation dictates that at a given instant of time, either the packet buffer 300, or alternatively the token bucket 306, is empty.

The token bucket regulation process 313 can be used to define a rate of transfer of packets from the line 200 to the line 222. The rate of transfer has two defining parameters, namely a “burst size” and a “mean rate”, where the mean rate specifies how much data can be sent or forwarded per unit time on average, and the burst size specifies how much data can be sent within a given unit of time.

The output rate is, in practice, limited by the output capacity of the line 222. The regulation imposed by the token bucket regulator 208 can be described mathematically by noting that the TBR 208 imposes on the input traffic on the line 200 a bound for all times t, s (0≦s≦t) such that the following mathematical inequality holds:

A(t)−A(s)≦σ+ρ(t−s) (1)

where A(t) is the number of bits on the line 222 in a time interval [0,t].

The term “leaky bucket” is also in common usage for a regulator which provides the above type of constraint.

The TBR 208 provides traffic shaping since it permits burstiness, but places a bound thereon. The TBR 208 guarantees that the number of bits on the line 102 in the time interval [s,t] never exceeds the token bucket capacity σ plus the time interval [t−s], multiplied by the token input rate ρ as shown in Equation (1).

The TBR regulation approach can provide guaranteed QoS, based upon peak-rate and other simplistic metrics, to users of terminals attached to a packet network. Thus for example, the “peak” QoS metric guarantees a peak rate for each terminal. However, since typical terminal input traffic, ie on the line 200, has a high peak-to-average traffic rate, peak-based traffic dimensioning makes inefficient use of network resources, and hence is uneconomical and not favoured by network operators or users.

Markov theory and effective bandwidth theory appear, at first glance, to provide a theoretical basis for determining economical network dimensioning on a basis other than peak-rate, for networks which carry stochastic packet traffic. The use of Markov modulated processes theoretically enables issues such as buffer overflow in network switches to be addressed, thereby providing a basis for network dimensioning and traffic engineering in cases where the traffic streams can be modelled as Markov processes. A major problem is encountered, however, when attempting to apply effective bandwidth methods to actual network traffic, since such network traffic is exceptionally difficult to model, and typically cannot be represented as Markov processes. Furthermore, actual network traffic typically contains long range correlations and elements of self-similarity, and such traffic is not able to be represented by Markov processes.

In order to illustrate the difficulties encountered in adopting Markov methods, an application thereof to an emerging network technology, which is capable of transporting and switching multi-service traffic, is considered. Asynchronous Transfer Mode (ATM) is one of the emerging network technologies which can support mixed traffic types. ATM connections fall into several classes, three of which will be considered. The connection types to be discussed are Constant Bit Rate (CBR), Variable Bit Rate (VBR) and Unspecified Bit Rate (UBR). Network infrastructure is typically provided to police network connections in such a manner that connections specified to be one of the aforementioned connection types are maintained within a corresponding envelope of performance characteristics. In the following description, the term “source” is used to represent a source of traffic which is policed in order to ensure that the traffic stream conforms to the necessary connection type definition.

A CBR connection requires, in general, only a Peak Cell Rate (PCR) traffic descriptor, where the PCR is the amount of bandwidth allocated to the CBR connection. A CBR service is expected, by a customer requiring such a connection, to comply with his stated PCR. A VBR connection, in contrast, requires at least three traffic descriptors, thereby distinguishing VBR traffic from CBR traffic. VBR connections require, in addition to the PCR, specification of a Sustainable Cell Rate (SCR) parameter, and an Intrinsic Burst Tolerance (IBT) parameter. Notwithstanding the additional overhead incurred in specifying the aforementioned additional parameters, a net benefit is found to accrue, in terms of an ability to share network resources. This benefit is realised in terms of a resource utilisation gain, which is commonly referred to as a “Statistical Multiplexing Gain” (SMG). In broad terms, there is thus a benefit to be had from setting up m (m>n) VBR connections, rather than merely setting up n CBR connections. Considering n sources with the same statistical characteristics, the SMG is expressed mathematically as follows:

SMG=n92 (1)−ρ(n) (2)

where ρ(1) is the bandwidth required to meet the QoS of one source,

ρ(n) is the bandwidth required to meet the QoS of n sources.

The significance of the SMG can be understood by considering a hypothetical network configuration having a traffic requirement of 150 connections. For a typical set of traffic descriptors, either 60 CBR connections, or alternately, 190 VBR connections, can be accommodated. This is equivalent to an SMG of 2×10⁶ cells per second (see “ATM Network Performance” by George Kesidis, Kluwer Press, 1996, Chapter 7 for more detail).

The aforementioned example requires both a knowledge of the statistics of the incoming traffic streams, and also a theoretical foundation upon which to calculate effective bandwidth, ie. ρₑ. Calculation of ρₑ requires that a specified bound be placed on the acceptable level of QoS which is added to source traffic as it traverses the network, and accordingly, ρₑ is a function associated with the incoming traffic stream. To be of practical value, ρₑ<PCR, because if ρₑ=PCR, the situation reverts to the CBR case (in which case the specification is that zero jitter be added to the traffic source). Thus, VBR traffic approaches a CBR traffic characteristic in the limit as jitter approaches zero, in which case ρₑ approaches the PCR of the policed traffic source.

A UBR connection, or, as it is termed in the telecommunications industry, a “best effort service”, is similar to a VBR connection, in that it is statistical (ie not CBR) in nature. However, a UBR connection is not associated with any formal traffic descriptors or quality of services (QoS) quarantees. UBR connections are typically provided when the network has excess bandwidth available, and UBR defined traffic is carried through the network with no performance guarantees.

Addressing the concept of effective bandwidth in more detail, it is instructive to consider the sequence x_{1,} x_{2 . . .,} ₙ being a sequence of n random variables. The aggregate of these variables Sₙ can be expressed mathematically as follows:

Sₙ=Σₖ₌ₗⁿxₖ (3)

where Sₙ is a summation of the random variables, and xₖ . . . are the random variables. The theory of large deviations can be used to calculate the probability of log P[Sₙ>ny], where “log” is the natural logarithm function, P( ) denotes a probability, and y is some variable. The desired probability, in the limit as n approaches infinity, is provided by the following mathematical representation:

log P[S_{n>}ny]=−nI(y) (4)

where: I(y) is the rate function of the input process.

The logarithm of the moment generating function Λ(θ) of the random variable x=x₁, is now introduced, this being expressed mathematically as follows:

Λ(θ)=log E(exp(θx)) (5)

where: E( ) is the expected value function, and

exp( ) is the exponential function.

In the general case where the variables x₁, x₂, . . . xₙ are not independently and identically distributed (i.i.d.), equation (5) is replaced by the following:

$$Λ ( θ ) = {lim}_{n -> ∞} \frac{1}{n} log E ( exp ( θ {\sum }_{k} {x}_{k} ) ) \qquad ( 6 )$$

This is referred to as the asymptotic log moment generating function (ALMGF).

For the purpose of this description, a traffic source having a “well defined ALMGF” is a traffic source having a “well defined entropy bound” as defined below.

Given the aforementioned definitions, the function I(y) (see (4)) can be written as follows:

$$I ( y ) = {sup}_{θ} ( θ y - Λ ( θ ) ) = {Λ ( y )}^{*} \qquad ( 7 )$$

where; Λ* is the Fenchel (ie. Legendre) transform of θ, and

sup is the supremum of this function.

Reference can be made, for example, to a book entitled “Large Deviation Techniques and Applications”. by A. Dembo, O. Zeitouni, Jones and Bartlett 1992 for further details.

The negative of the rate function I(y), ie. −I(y) is commonly referred to as the entropy function of the input process. Assuming the existence of a well defined entropy function (−I(y) for a given input sequence x₁, x₂, . . . xₙ, the equivalent bandwidth ρₑ of that sequence can be expressed mathematically as follows:

ρ_{c}(θ)=Λ(θ)/θ (8)

For the purposes of this description the terms “well defined entropy bound” and “pre-determined entropy bound” mean that the data traffic is conditioned so that when it enters a downstream buffer, a plot of the Log P (i.e. probability of buffer occupancy) versus buffer occupancy has an upper bound which approaches a straight line in the large buffer limit. It is noted that ρ_{e≧ρ}ₘ, where ρₘ is the mean rate of the source. Given j sources each with effective bandwidths ρₑ ^{j,}, then if this aggregation of j sources enters a buffer of size B, where the buffer has an output rate ρ then:

$${\sum }_{j} {ρ}_{e}^{j} \leq ρ ⇒ {lim}_{B -> ∞} \frac{1}{B} ln P \{ X > B \} \leq - θ \qquad ( 9 )$$

where: X is the buffer occupancy.

Effective bandwidth, ie. ρₑ, is often associated with the problem of inputting a traffic stream into a buffer which has a single output rate ρ. ρₑ can be specified to be a value which guarantees, in the limit of large buffer occupancy, that the slope of the log P versus buffer occupancy is a straight line with slope θ_{q}. The value of ρwhich meets this condition can be expressed mathematically as follows:

ρ_{c}θₒ−Λ(θₒ)=0 (10)

Assuming that a traffic source has a well defined ALMGF Λ(θ), then the parameter θis set in a manner which places a tolerance on acceptable QoS. Thereafter, Equation (8) can be used to calculate the effective bandwidth ρₑ. The fact that this ρ_{c} is less than the PCR of the traffic being considered illustrates the fact that resource utilisation gain has been achieved.

The mathematical formulation described by equations (1)-(10) can be applied to a telecommunications network application, and in particular a Call Admission Control (CAC) procedure on an ATM VBR link. An arrangement is considered in which a Network Management Administrator (NMA) is managing a network node having n input links, and a single output link with rate R bits/s. If the input links are to be scheduled for transmission over the output link in such a manner that the desired QoS requirements for each input link arm to be satisfied, then the Network Management Administrator must allocate a requisite amount of available network bandwidth to each of n corresponding users. When a new user appears and requests a specific QoS for his new traffic stream, the Network Management Administrator must decide, typically in real time in a practical network situation, whether the resources are available to accommodate this new request. This is the CAC procedure. For the purposes of the following analysis, all existing and new traffic sources are assumed to possess well defined ALMGF Λ(θ).

The Network Management Administrator uses the concept of effective bandwidth to make a decision. If the new user offers traffic, and requests a QoS defined by a value αₒ, the Network Management Administrator must solve the following mathematical equation:

ρ_{c}=Λαₒ)/αₒ (11)

where: αₒ has been previously defined in relation to equation (10).

If unallocated network bandwidth greater than the aforementioned value of ρ_{c} is available, then the new user can be accepted for connection to the network. If, however, unallocated bandwidth is not available to this extent, then the new connection is refused.

FIG. 4 depicts the CAC problem in graphical terms. The abscissa in this figure indicates how many users can be connected to the network dependent upon an amount of bandwidth allocated to each user, noting that there are three different types of allocation schemes depicted, as indicated by the ordinate. FIG. 4 shows a plot of bandwidth requirements 700 as a function of a number of active sources (ie calls) or users, 702.

A lower curve 708 shows a number of users which can be connected if only the average bandwidth of each source is allocated to each user. In this case, a large number of users 716 can be accommodated, however the QoS guaranteed to each user is poor. A centre curve 706 is a “middle ground”, for which ideally, effective bandwidth theory is used to obtain benefit from a higher QoS specification, while still retaining an advantage from statistical multiplexing. In this case, a number of users 714, which is less than the previous number of users 716, can be accommodated, but each user has the benefit of a better QoS guarantee than in the case of the curve 708. Finally, an upper curve 704 shows the number of users which can be allocated if peak bandwidth is assigned to each user. In this case, no statistical multiplexing gain is available, however a high QoS is achieved (ie. essentially zero delay). This high QoS is achieved at the expense, however, of minimising the number of allowed users (ie. to a level depicted by a reference numeral 712).

In practice, determination of the centre curve cannot presently be achieved in a quantitative fashion. Solution of the Connection Admission Control problem requires availability of a well defined ALMGF Λ(θ) (see Equation (6)) for the various traffic sourccs being considered. This well defined moment generating function leads, in turn, to a requirement for a well defined entropy function −I(y) as defined by Equation (7). Mathematically, a number of well known models of traffic sources, such as Poisson, Bernoulli, and Markov process, have well defined entropy, however, real traffic sources cannot, in general, be modelled by such mathematically convenient descriptions.

Real traffic sources are more complex, and can involve long range correlations. This divergence between real world traffic and the mathematical models typically used to model traffic, is at the core of the problem underlying the application of mathematical and engineering theory to real packet networks. Accordingly, the Connection Admission Control procedure previously outlined does not produce usable results in practice, and “rule of thumb” techniques must typically be resorted to. This derives from the fact that real traffic sources have ill-defined entropy, and consequently, that effective bandwidth theory cannot be applied. Therefore, accurate resource requirements and allocation cannot be determined. Accordingly, network engineers must fall back on use of simulations, or experience of past traffic specifications to estimate the effective bandwidth in order to “solve” the CAC problem posed above.

### SUMMARY

Thus a need clearly exists for an improved method of regulating packet traffic to substantially overcome, or at least ameliorate, one or more disadvantages of existing arrangements.

According to a broad aspect of the invention, there is provided a method of shaping input packet traffic, said method comprising steps of.

determining a constraint parameter dependent upon a probability density function; and

constraining, based upon said parameter, transmission of the input packet traffic, thereby to produce output packet traffic having a predetermined entropy bound.

According to another broad aspect of the invention, there is provided a packet traffic shaper comprising:

determination means configured to determine a constraint parameter dependent upon a probability density function; and

constraining means configured to constrain, based upon the parameter, transmission of traffic input to said constraining means, thereby to produce output traffic having a pre-determined entropy bound.

According to still another broad aspect of the invention, there is provided a computer readable memory medium for storing a program for an apparatus which shapes input packet traffic, said program comprising:

code for a determining step for determining a constraint parameter dependent upon a probability density function, and

code for a constraining step for constraining, based upon said parameter, transmission of the input packet traffic, thereby to produce output packet traffic having a pre-determined entropy bound.

According to yet another broad aspect of the invention, there is provided a computer program for an apparatus which shapes input packet traffic, said program comprising:

code for a determining step for determining a constraint parameter dependent upon a probability density function; and

code for a constraining step for constraining, based upon said parameter, transmission of the input packet traffic, thereby to produce output packet traffic having a pre-determined entropy bound.

According to a further broad aspect of the invention, there is provided a method of policing input packet traffic, said method comprising steps of:

determining a constraint parameter dependent upon a probability density function; and

tagging, based upon said parameter, conforming packets in the input packet traffic, thereby to produce output packet traffic wherein tagged packets comprise a policed traffic stream having a pre-determined entropy bound.

According to yet another broad aspect of the invention, there is provided a packet traffic policer comprising:

determination means configured to determine a constraint parameter dependent upon a probability density function; and

tagging means configured to tag, based upon the parameter, conforming packets in traffic input to said tagging means, thereby to produce output traffic wherein tagged packets comprise a policed traffic stream having a pre-determined entropy bound.

According to still another broad aspect of the invention, there is provided a computer readable memory medium for storing a program for an apparatus which polices input packet traffic, said program comprising:

code for a determining step for determining a constraint parameter dependent upon a probability density function; and

code for a tagging step for tagging, based upon said parameter, conforming packets in the input packet traffic, thereby to produce output packet traffic wherein tagged packets comprise a policed traffic stream having a predetermined entropy bound.

According to another broad aspect of the invention, there is provided a computer program for an apparatus which polices input packet traffic, said program comprising:

code for a determining step for determining a constraint parameter dependent upon a probability density faction; and

code for a tagging step for tagging, based upon said parameter, conforming packets in the input packet traffic, thereby to produce output packet traffic wherein tagged packets comprise a policed traffic stream having a pre-determined entropy bound.

According to yet another broad aspect of the invention, there is provided a method of controlling admission of a proposed additional input packet traffic stream to a network node, said node having a prior input packet traffic stream, and an output packet traffic stream carried on a link having an associated maximum bandwidth, said method comprising steps of:

shaping the prior input packet traffic stream to have a corresponding pre-determined entropy bound if said prior stream does not have said corresponding pre-determined entropy bound;

shaping the proposed additional input packet traffic stream to have a corresponding pre-determined entropy bound if said proposed stream does not have said corresponding pre-determined entropy bound;

determining corresponding equivalent bandwidths for the prior traffic stream and the proposed additional traffic stream; and

admitting the proposed additional traffic stream if a sum of the corresponding equivalent bandwidths of the prior traffic stream and the proposed additional traffic stream does not exceed said maximum bandwidth.

According to a further broad aspect of the invention, there is provided a connection admission controller configured to control admission of a proposed additional input packet traffic stream to a network node, said node having a prior input packet traffic stream, and an output packet traffic stream carried on a link having an associated maximum bandwidth, said controller comprising:

first shaping moans configured to shape the prior input packet traffic stream to have a corresponding predetermined entropy bound if said prior stream does not have said corresponding pre-determined entropy bound;

second shaping means configured to shape the proposed additional input packet traffic stream to have a corresponding pre-determined entropy bound if said proposed stream does not have said corresponding pre-determined entropy bound;

determining means configured to determine corresponding equivalent bandwidths for the prior traffic stream and the proposed additional traffic stream, and admission means configured to admit the proposed additional traffic stream if a sum of the corresponding equivalent bandwidths of the prior traffic stream and the proposed additional traffic stream does not exceed said maximum bandwidth.

According to yet another broad aspect of the invention, there is provided a computer readable memory medium for storing a program for an apparatus which controls admission of a proposed additional input packet traffic stream to a network node, said node having a prior input packet traffic stream, and an output packet traffic stream cared on a link having an associated maximum bandwidth, said program comprising:

code for a first shaping step for shaping the prior input packet traffic stream to have a corresponding pre-determined entropy bound if said prior stream does not have said corresponding pre-determined entropy bound;

code for a second shaping step for shaping the proposed additional input packet traffic stream to have a corresponding pre-determined entropy bound if said proposed stream does not have said corresponding pre-determined entropy bound;

code for a determining step for determining corresponding equivalent bandwidths for the prior traffic stream and the proposed additional traffic stream; and

code for an admitting step for admitting the proposed additional traffic stream if a sum of the corresponding equivalent bandwidths of the prior traffic stream and the proposed additional traffic stream does not exceed said maximum bandwidth.

According to still another broad aspect of the invention, there is provided a computer program for an apparatus which controls admission of a proposed additional input packet traffic stream to a network node, said node having a prior input packet traffic stream, and an output packet traffic stream carried on a link having an associated maximum bandwidth, said program comprising:

code for a first shaping step for shaping the prior input packet traffic stream to have a corresponding pre-determined entropy bound if said prior stream does not have said corresponding pre-determined entropy bound;

code for a second shaping step for shaping the proposed additional input packet traffic stream to have a corresponding pre-determined entropy bound if said proposed stream does not have said corresponding pre-determined entropy bound,

code for a determining step for determining corresponding equivalent bandwidths for the prior traffic stream and the proposed additional traffic stream; and

code for an admitting step for admitting the proposed additional traffic stream if a sum of the corresponding equivalent bandwidths of the prior traffic stream and the proposed additional traffic stream does not exceed said maximum bandwidth.

According to another broad aspect of the invention, there is provided a method of adjusting a present bandwidth allocated to a packet traffic stream to thereby achieve a desired quality of service, said method comprising steps of:

determining a target equivalent bandwidth required by said traffic stream to meet said desired quality of service;

determining a differential bandwidth dependent upon the present bandwidth and the target equivalent bandwidth;

determining, based upon said differential bandwidth, a probability distribution function and

constraining, based upon said probability distribution function, transmission of the packet traffic stream, thereby (i) producing an output packet traffic having a pre-determined entropy bound, (ii) allocating to the input traffic stream said target equivalent bandwidth and (iii) achieving said desired quality of service.

According to still another broad aspect of the invention, there is provided an apparatus configured to adjust a present bandwidth allocated to a packet traffic stream to thereby achieve a desired quality of service, said apparatus comprising:

first determining means configured to determine a target equivalent bandwidth required by said traffic stream to meet said desired quality of service;

second determining means configured to determine a differential bandwidth dependent upon the present bandwidth and the target equivalent bandwidth;

third determining means configured to determine, based upon said differential bandwidth, a probability distribution function; and

constraining means configured to constrain, based upon said probability distribution function, transmission of the packet traffic stream, thereby (i) producing an output packet traffic having a predetermined entropy bound, (ii) allocating to the input traffic stream said target equivalent bandwidth and (iii) achieving said desired quality of service.

According to a further broad aspect of the invention, there is provided a computer readable memory medium for storing a program for an apparatus configured to adjust a present bandwidth allocated to a packet traffic stream to thereby achieve a desired quality of service, said program comprising:

code for a first determining step for determining a target equivalent bandwidth required by said traffic stream to meet said desired quality of service;

code for a second determining step for determining a differential bandwidth dependent upon the present bandwidth and the target equivalent bandwidth;

code for a third determining step for determining, based upon said differential bandwidth, a probability distribution function; and

code for a constraining step for constraining, based upon said probability distribution function, transmission of the packet traffic stream, thereby (i) producing an output packet traffic having a pre-determined entropy bound, (ii) allocating to the input traffic stream said target equivalent bandwidth and (iii) achieving said desired quality of service.

According to another broad aspect of the invention, there is provided a computer program for an apparatus configured to adjust a present bandwidth allocated to a packet traffic stream to thereby achieve a desired quality of service, said program comprising:

code for a first determining step for determining a target equivalent bandwidth required by said traffic stream to meet said desired quality of service;

code for a second determining step for determining a differential bandwidth dependent upon the present bandwidth and the target equivalent bandwidth;

code for a third determining step for determining, based upon said differential bandwidth, a probability distribution function; and

code for a constraining step for constraining, based upon said probability distribution function, transmission of the packet traffic stream, thereby (i) producing an output packet traffic having a predetermined entropy bound, (ii) allocating to the input traffic stream said target equivalent bandwidth and (iii) achieving said desired quality of service.

### BRIEF DESCRIPTION OF THE DRAWINGS

A number of preferred embodiments of the present invention are described hereinafter with reference to the drawings, in which:

FIG. 1 shows a Quality of Service (QoS) model within and across networks;

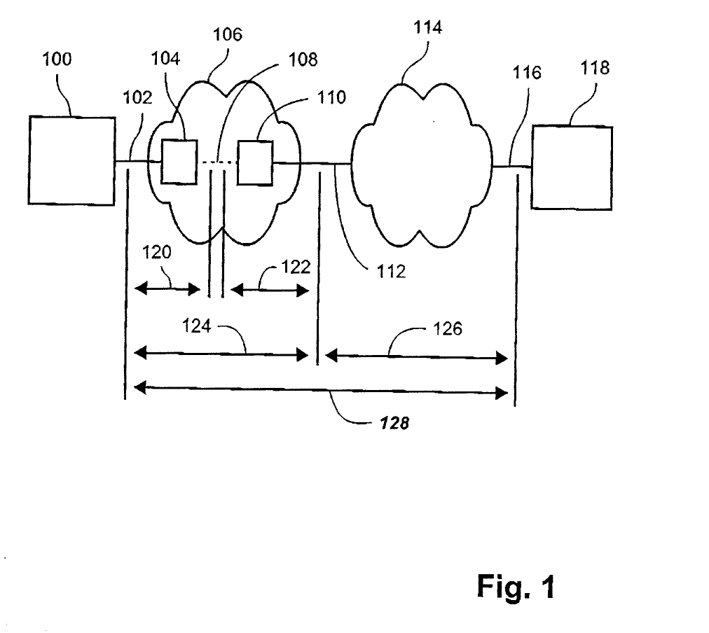

FIG. 2 shows an arrangement for aggregation and regulation of traffic;

FIG. 3 depicts a prior art token bucket regulator;

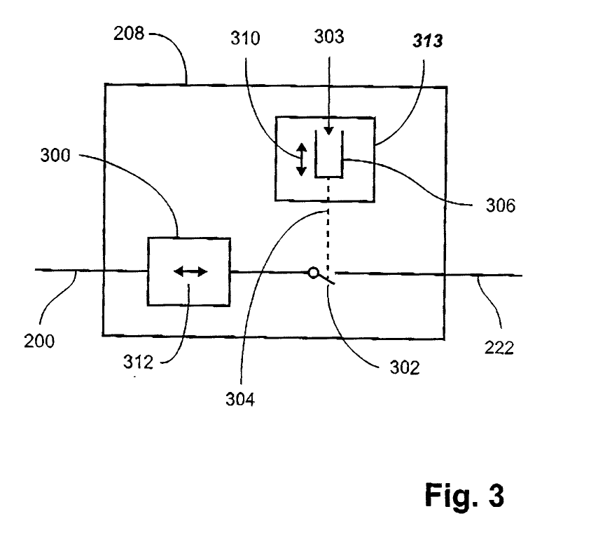

FIG. 4 depicts user volume/performance curves in a network;

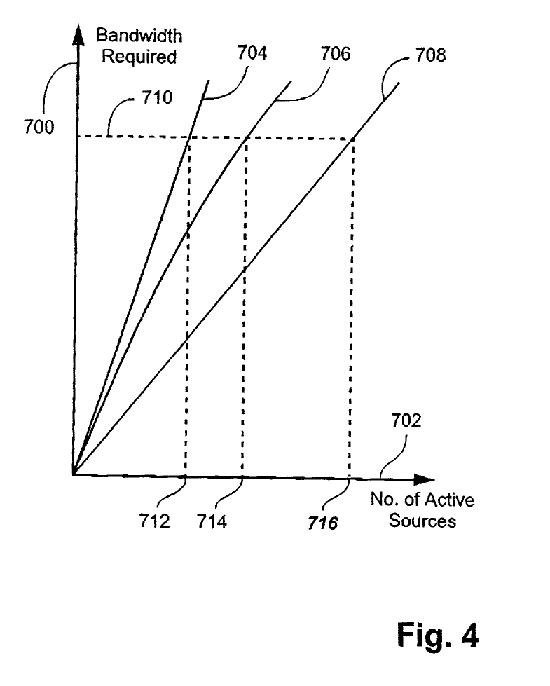

FIG. 5 shows one arrangement of an entropy shaper;

FIG. 6 shows one arrangement of an entropy policer;

FIGS. 7A and 7B show a flowchart of method steps for the shaper of FIG. 5;

FIGS. 8A and 8B show a flowchart of method steps for the policer of FIG. 6;

FIG. 9 shows unregulated TCP/IP traffic;

FIG. 10 shows the traffic depicted FIG. 9 after regulation in accordance with the shaper of FIG. 5;

FIG. 11 is a schematic block diagram of a general purpose computer upon which arrangements of entropy regulators can be practiced; and

FIG. 12 is a schematic block diagram of a special purpose processor upon which arrangements of entropy regulators can be practiced.

### DETAILED DESCRIPTION

Where reference is made in any one or more of the accompanying drawings to steps and/or features, which have the same reference numerals, those steps and/or features have for the purposes of this description the same function(s) or operation(s), unless the contrary intention appears.

A new regulation device, referred to as an “Entropy Regulator” (ER), is disclosed. The ER imposes probabilistic, rather than deterministic, upper bounds on traffic flows. In general, the ER can impose a pre-determined entropy bound on traffic. Traffic having been constrained in this manner then has desirable properties, as described below. In particular, a specific type of imposed entropy bound, ie an entropy bound related to Exponentially Bounded Burstiness (EBB), is found to have particular advantages in relation to telecommunications networks operation and planning (see “Performance and Stability of Communication Networks via Robust Exponential Bounds”, O. Yaron and M. Sidi, IEEE Transactions on Networking, Vol. 1, No. 3, pp. 372-385, June 1993).

The particular ER which achieves EBB (this regulator being referred to as an EBB/ER in the description) is capable, by careful selection of two parameters which control a statistical constraint parameter imposed on traffic input to the EBB/ER, of imposing EBB on traffic which is output by the EBB/ER. This achievement of EBB traffic allows effective bandwidth principles to be applied, enabling much more efficient use of network resources to be achieved.

Use of the EBB/ER allows network users to define their network performance requirements in terms of a statistical probability of achieving a desired QoS, rather than by specifying a deterministic QoS bound. This approach proves to be more cost effective than traditional methods, which typically use simple QoS metrics such as peak rate, or alternately use inaccurate rule-of-thumb approaches. From a purely illustrative perspective, it can be visualised that whereas in the TBR, the token bucket remains fixed in size, in the EBB/ER the size of the token bucket becomes a random variable W, having a chosen probability distribution function. During operation, in a chosen time-slot t, a uniform random variate x, is chosen which sets the value of W for that time-slot.

As noted, EBB traffic is particularly tractable in terms of traffic engineering and network dimensioning since EBB traffic allows use of effective bandwidth tools. EBB traffic also has the property that if all traffic entering the network is EBB, then aggregations of traffic within the network are also EBB. This allows probabilistic bounds of QoS parameters such as time delay to be calculated throughout such a network.

By using the EBB/ER, real traffic sources can be regulated in such a manner that a deterministic bound is placed on the entropy of traffic output from the regulating device. Consequently a pre-determined firm upper bound to the effective bandwidth necessary to meet a required QoS specification can be determined.

A first arrangement of the entropy regulator has, at its core, a process providing a constraint parameter to which the regulated output traffic flow must conform. This constraint can be expressed mathematically as follows:

Pr{O(t)−O(s)≦(t−s)ρ+f(α,x)}≦F(α,σ) (12)

for all times s(0≦s≦t),

where: O(t) is the number of bits seen on the regulated output flow in the time interval [0,t],

Pr is the probability;

ρis an as yet unspecified rate; and

F is a distribution function involving parameters α and σ.

A function f, being the inverse function of F, is used to realise the form of F from a uniform random variate x(0≦×≦1). In general, any type of probability distribution function for F can be used. For example, if F is defined by the following mathematical expression:

F(ασ)=1−e^{-ασ} (13)

then the following corresponding inverse representation is derived:

f(α,x)=(1/α)log[1−x]⁻¹ (14)

Given Equation (14), the process producing traffic which satisfies the constraint of equation no. (12) satisfies, for all times s, the following mathematical equation:

Pr{O(t)−O(s)≧(t−s)ρ+σ≦}e^{-ασ} (15)

Traffic which satisfied equation (15) is said to possess Exponential Bounded Burstiness (EBB). Accordingly, the preferred arrangement of the entropy regulator which utilises F as defined by Equation (13) provides an output traffic stream which has exponentially bounded burstiness. An advantage of the described approach is that there exists an analytical expression, ie. Equation (14), for the inverse of the distribution function defined in Equation (13).

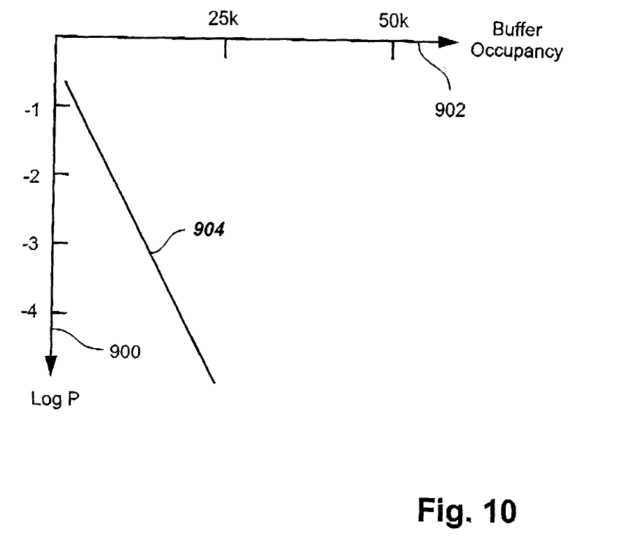

Many types of traffic sources, including Markov Modulated processes, satisfy the EBB constraint equation for some α and ρ. For such traffic, a straight line bound 904 of the Log P vs. Buffer plane (see FIG. 10) is obtained in the large buffer limit.

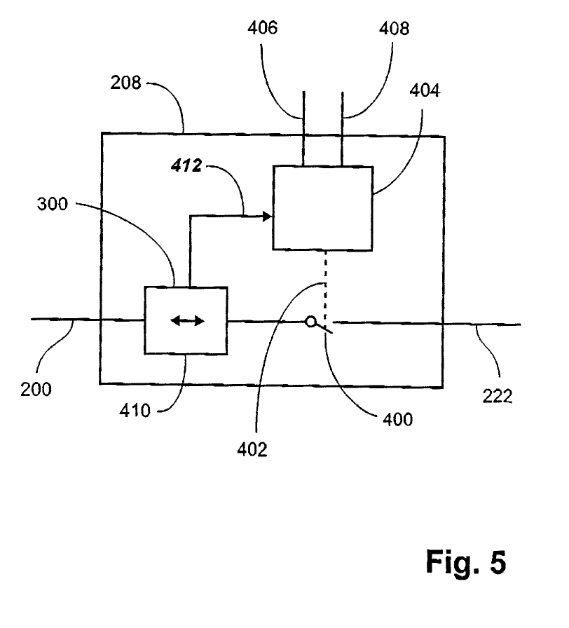

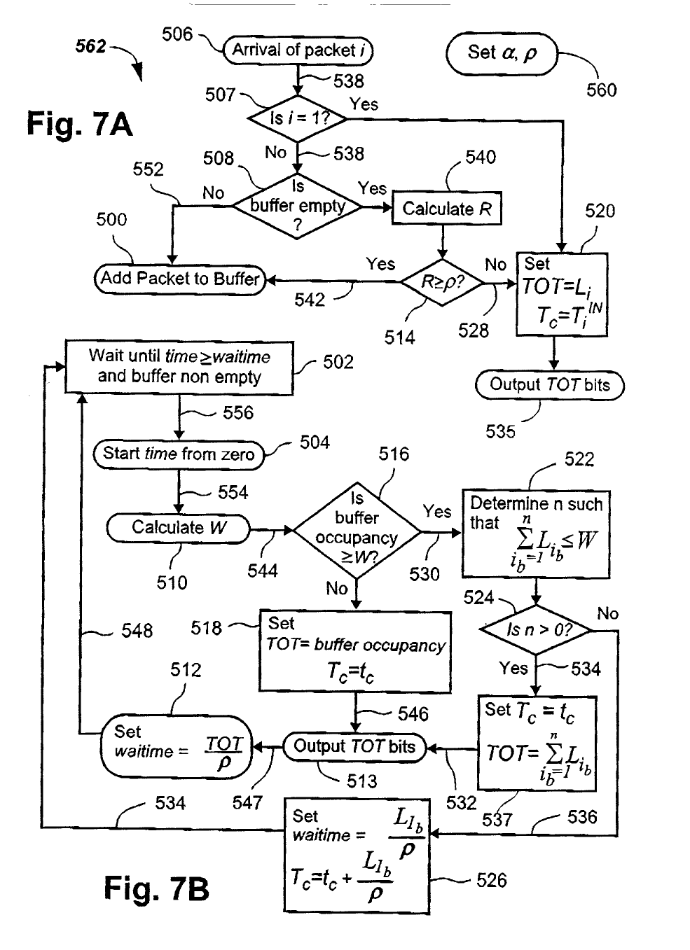

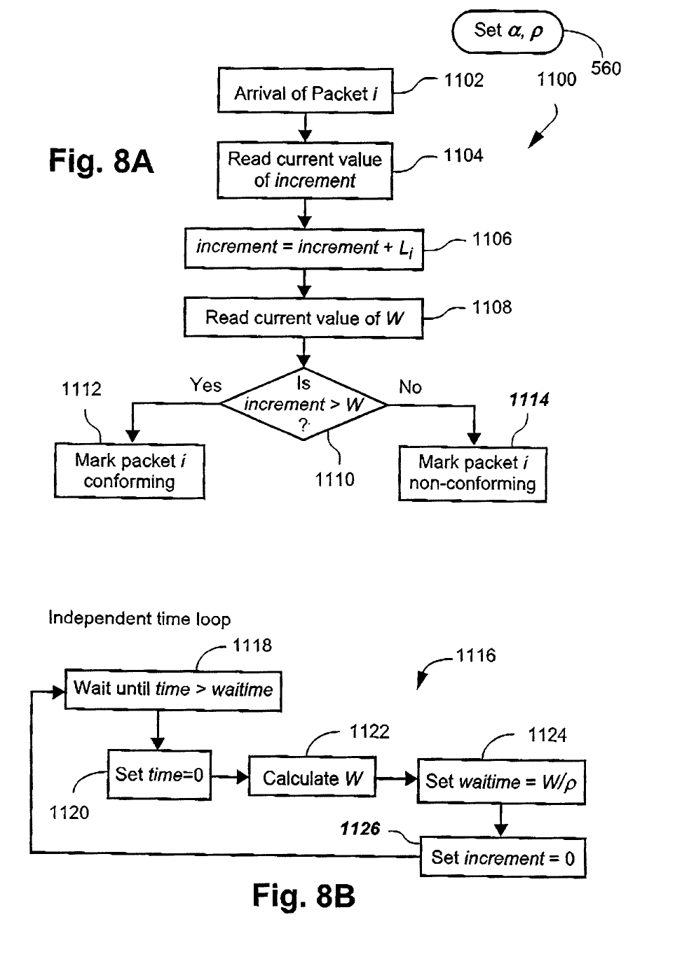

Although the description considers the EBB approach in detail, as previously noted, traffic which satisfies the EBB constraint equation is a special case of the more generalized constraint obtained by the use of any type of distribution function F in the constraint Equation (12). Use of the specific F defined in Equation (13) leads to production of EBB traffic. The arrangements described in relation to FIGS. 5-8, which relate specifically to EBB traffic, can be readily altered to provide bounds on the traffic which are not EBB, but which still satisfy other, well formed entropy, constraints. This is achieved, for an entropy traffic shaper by replacing the function f (ie the inverse of the distribution function F in Equation (13)), which is used to determine the “bucket size” at the control step 510 (see FIGS. 7A, 7B) by an alternative function. In the case of the entropy policer, the function f is replaced at the equivalent control step 1122 in FIG. 8B.

Use of the generalized constraint covers a much broader spectrum of traffic sources, including those possessing sub-exponentially bounded burstiness such as “self-similar fractional Brownian Motion” (see “Stochastically Bounded Burstiness for Communication Networks”, D. Starobinski and M. Sidi, IEEE Transactions on Information Theory Vol. 46, No. 1, pp. 206-212, Jan. 2000 for further details). An advantage of generalizing the constraint is that for some particular traffic sources, the bounds imposed by use of the generalized constraint may be tighter than those achievable using EBB, and this may be more useful in providing yet further improved network utilisation. Such traffic may, however, not lead to the straight line bound 904 in the Log P vs. Buffer plane (see FIG. 10).

Returning to the EBB traffic case, considering the particular case where F has the form provided in Equation (13), the traffic, as noted, possesses EBB. In this case, the parameters which specify output from the EBB/ER are (ρ, α), rather than (ρ, σ) as was the case n the TBR as expressed mathematically in Equation (1). In the EBB/ER, ρ represents the mean output rate, and a represents the probability slope parameter (represented by the slope of the line 904 in FIG. 10). By careful selection of the (ρ, α) parameter pair, the output from the EBB/ER can be shown to always satisfy Equation (15), which is restated here for ease of reference:

Pr{O(t)−O(s)≧(t−s)ρ+σ}≦e^{-ασ} (16)

for all s, 0≦s≦t.

After setting the value of α in the EBB/ER, the user can specify a particular value for the upper bound on the probability of a given burst size σ being present in his traffic. This is a practical method by which the user can define a service QoS specification to the network provider. The value of ρ must, however, be chosen so as to satisfy Equation (16). This requires that ρ be at least equal to the mean rate of the input traffic. Most traffic which can be described by a Markov process will be EBB as defined by Equation (16).

FIG. 5 shows a block diagram representation of a preferred arrangement of the EBB/ER acting as a traffic shaper. Traffic is input on the input path 200 to the shaper 208, the traffic being input into the FIFO buffer 300. The contents of the buffer 300 are output onto the output path 222 under control of a buffer switch 400, the switch being controlled by an entropy regulation module 404 by means of a control signal depicted by a dashed line 402. The entropy regulation process 404 is notified by a signal 412 emanating from the buffer 300 of (i) the arrival of a packet in the buffer 300, and (ii) the length 410 of the packet (denoted by Lᵢ). The entropy regulation module 404 is characterised in terms of two input parameters, namely the probability slope parameter α, which is input on a line 406, and the mean output rate parameter ρ, which is input on a line 408. The entropy shaper 208 imposes an entropy bound on the incoming traffic on the path 200, thereby producing regulated output traffic on the path 222, the output traffic being characterised by a pre-determined entropy bound.

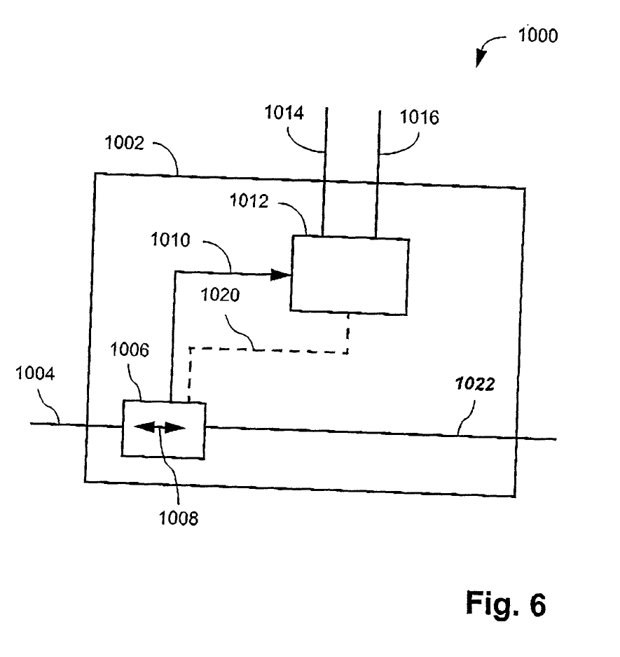

FIG. 6 shows a block diagram representation of a preferred arrangement of the EBB/ER acting as a traffic policer. Traffic is input on the input path 1004 to the policer 1002, the traffic being input into a buffer 1006. The contents of the buffer 1006 are output onto the output path 1022 after being operated on by a packet marker signal 1020, the packet marker signal being output by an entropy regulation process 1012. The packet marker signal 1020 in this arrangement tags, or marks packets as conforming or non conforming, dependent upon the regulation process 1012. Marking can be performed by marking conforming packets, marking non-conforming packets, or appropriately marking both conforming and non-conforming packets. The entropy regulation process 1012 is notified, by a signal 1010 emanating from the buffer 1006 of (i) the arrival of a packet in the buffer 1006, and (ii) the length 1008 of the packet (denoted by Lᵢ). The entropy regulation process 1012 is characterised in terms of two input parameters, namely the probability slope parameter α, which is input on αline 1014, and the mean output rate parameter ρp, which is input on a line 1016. The entropy policer 1002 imposes an entropy bound on the incoming traffic on the path 1004, thereby producing output traffic on the path 1022, where conforming packets in the output traffic are characterised by a pre-determined entropy bound, related to EBB in the preferred arrangement. Alternatively the policer can discard non-conforming packets.

In regard to the traffic shaper, the input traffic on the path 200 can be either traffic already having a pre-determined entropy bound, or alternatively, can be traffic having characteristics that are completely general. For either type of input traffic, the traffic shaper 208 produces output traffic on the path 222 having a pre-determined entropy bound irrespective of the nature of the incoming traffic on the path 200. Turning to the traffic policer 1002, for either type of input traffic, the traffic policer 1002 produces output traffic on the path 1022 wherein packets which are marked as conforming in that traffic stream have a pre-determined entropy bound irrespective of the nature of the incoming traffic on the path 1004. It is instructive to recall that if input traffic to a standard network element is non-Markovian, noting that such traffic does not have a pre-determined entropy bound, then the resulting output traffic from the standard network element is generally also non-Markovian. Furthermore, even if Markovian traffic, ie traffic having a predetermined entropy bound, is input into the standard network element, the standard network element can in many cases modify this traffic thereby outputting non-Markovian traffic. Systems with this characteristic can not in general be analysed quantitatively.

FIGS. 7A and 7B are flowcharts showing a preferred arrangement of an entropy regulation process 562 configured as a traffic shaper. This relates to the entropy shaper described in relation to FIG. 5. FIGS. 7A and 7B comprise two independent threads of method steps, in respect of which reference should be made to Table 1, and the subsequent explanatory notes.

TABLE 1
i = packet number where subscript b mean packet is in buffer, initially i
is zero and increments by one for every packet arrival.
Lᵢ = packet length in bits For example L₁_{_{b}} is the length of the first packet
in the buffer
TOT is total number of bits to be transmitted
Tᵢ^{IN} = Arrival time of packet at buffer
Tᵢ^{OUT} = Departure time of packet from buffer
T_{c} = conforming time
t_{C} = current real time
$R = \frac{{L}_{1} + TOT}{{T}_{t}^{IN} - {T}_{c}}$
ρ = rate of Entropy Regulator
α = probability parameter of Regulator

### Explanatory Notes

W is calculated by selecting a random number x in the range 0-1 (uniformly) and then setting:

W(x,α)=F⁻¹(x,α)

In this description, a specific value of the function W(x,α), as evaluated for specific values of x,α, is denoted as W.

For example the following function results in EBB traffic:

F⁻¹(x,α)=(1/α)log[1−x]⁻¹

The initial settings are T_{c=}0 waitime=0, and time=0.

Turning to FIG. 7A, the entropy regulation process 562 commences, in an initialisation step 560, by setting parameters a (ie. the probability parameter of the regulator), and ρ (ie. the rate of the entropy regulator).

For every packet arrival at the buffer 300 (see FIG. 5), this arrival being notified by the buffer 300 on the line 412 (see FIG. 5), the process 562 determines at what time the packet may be output from the regulator 208.

In a first process thread, a packet arrival for a packet i is detected in a step 506, after which a test in a step 507 is performed to determine if packet i is the first packet to arrive. If the packet i is the first packet, then the process 562 is directed in accordance with a “yes” arrow from the step 507 to a set step 520, and then to an output step 535 If the packet i is not the first packet, then the process 562 is directed in accordance with a “no” arrow from the step 507 to a test step 508 where a test is performed for an “buffer empty” condition. If, in the step 508, the buffer is found to be empty, then in accordance with a “yes” arrow, a variable R (see the explanatory notes for a definition thereof) is calculated in a step 540, and R is then tested against ρ in a step 514. This is a conformance test which considers the length of the packet i, and that of a preceding packet, and also an arrival time for the packet i and a “conforming time” as shown in the preceding Explanatory Notes. If R is found, in the step 514, to be not greater than ρ, or equal thereto, then the regulator process 562 is directed in accordance with a “no” arrow 528 to the setting step 520, where the conforming time and a number of bits (denoted by TOT) which are able to be sent on the output line 222 (see FIG. 5), are set as indicated. The process 562 then proceeds to the step 535 where the control signal 402 causes TOT bits of data from the regulator to be output on the line 222 (see FIG. 5). If in contrast, R is found to be greater than or equal to ρ in the step 514, then the regulator process 562 is directed in accordance with a “yes” arrow 542 to a step 500, in which the packet i is left in the buffer 300. Returning to the step 508, if the buffer 300 is found not to be empty, then the regulator process 562 is directed in accordance with a “no” arrow 552 to the step 500, where the packet i is left in the buffer.

In a second process thread (see FIG. 7B), the regulator process 562 waits, in a step 502, until a time value exceeds a variable “waitime” and the buffer 300 is not empty. Packets are added to the buffer 300 by the first process thread. Thereafter, in a step 504, the time is reset and started again from zero, after which the regulator process 562 is directed, in accordance with an arrow 554, to a step 510 in which the value of the variable W is calculated. Thereafter, if the buffer occupancy according to a step 516 exceeds, or equals W. then the regulator process 562 is directed, in accordance with a “yes” arrow 530, to a determination step 522. If, on the other hand, in the step 516 the number of packets in the buffer is found to be less than W, then the regulator process 562 is directed to a setting step 518.

Returning to the determination step 522, this step determines the value of the parameter n as described. Thereafter, the regulator process 562 is directed to a testing step 524, where the value of n (which was determined in the step 522) is tested against zero. If n is not greater than zero then the regulator process 562 is directed in accordance with a “no” arrow 536 to a step 526, where variables as described in FIG. 7B are set. Thereafter, the regulator process 562 is directed in accordance with an arrow 534, back to the waiting step 502.

Returning to the setting step 518, to which the regulator process 562 is directed in the event that the buffer 300 occupancy is less than R (see the step 516), variables are set, in the step 518 as indicated in FIG. 7B Thereafter, the process 562 is directed in accordance with an arrow 546 to a step 513, in which the control signal 402 (see Fig, 5) causes TOT bits of data from the regulator 208 to be output on the line 222, after which the regulator process 562 is directed in accordance with an arrow 547 to a step 512 where the variable waitime is set as indicated. Thereafter, the regulator process 562 is directed, in accordance with an arrow 548, back to the step 502. If the step 524 concluded that n was greater than zero, then the regulator process 562 is directed in accordance with a “yes” arrow 534 to the step 537 where variables as described in FIG. 7B are set. Thereafter, the regulator process 562 is directed to the step 513 where the control signal 402 causes TOT bits of data from the regulator to be output on the line 222. After this the regulator process 562 is directed in accordance with the arrow 547 as described above.

The entropy shaping process which has been described in relation to FIGS. 7A and 7B, is represented in pseudo-code form in Table 2 hereinafter.

As noted, the regulating process in FIGS. 7A and 7B has been configured as a traffic shaper. With some modifications, the process can be configured as a traffic policer. In this mode non-conforming packets are simply marked as such and no buffering delay is incurred. One modification which allows for this mode, is to maintain the bucket size at the value given by W as in the shaper. During calculation of waitime (as defined in steps 512 and 526 of FIG. 7B) a counter starting from zero is incremented. When this counter exceeds the current W, any subsequent packets arriving are marked as non-conforming. After waitime has elapsed, the process is repeated. No packets are added to any waiting buffer. We call the ER operating in this mode the Policer-ER (P-ER).

FIGS. 8A and 8B show an arrangement of an entropy regulation process having two process threads 1100, 1116. The regulation process is configured as a traffic policer, and is depicted by a flowchart of method steps. This process is associated with the entropy policer described in relation to FIG. 6. FIGS. 8A and 8B comprise a flow chart of method steps, in respect of which reference should be made to Table 1, and the subsequent “Explanatory Notes”.

FIG. 8A depicts the first process thread 1100, which commences with detection at the buffer 1006 of an arrival of a packet in a step 1102. Thereafter, in a step 1104 a current value of the variable increment is read. The variable increment is obtained from the second process thread 1116 which is described in relation to FIG. 8B. Returning to the first process thread 1100, the process then proceeds to a step 1106 in which the variable increment is incremented as indicated in FIG. 8A by addition of Lᵢ, which is the packet length in bits, as defined in Table 1. The packet length Lᵢ is provided on the arrow 1010 from the buffer 1006. Thereafter, in a step 1108, a current value of W is read, after which, in a step 1110, the variable increment is tested against the variable W. If increment is greater than W, then the thread 1100 is directed in accordance with a “yes” arrow to a step 1112 in which the packet i is marked as being conforming, as depicted by the arrow 1020. If, on the other hand, increment is not greater than W. then the thread 1100 is directed from the decision step 1110 in accordance with a “no” arrow to a step 1114, in which the packet i is marked as non-conforming as depicted by the arrow 1020. Accordingly, the thread 1100 runs for each arriving packet, and results in the arriving packet being marked as either conforming or non-conforming. After the packet is so marked, the packet is immediately transmitted on the line 1022.

FIG. 8B depicts the second process thread 1116 which is an independent time loop within which W and increment are determined, these variables being used by the first thread 1100. The second thread 1116 is a continuous loop, and for ease of explanation is described by commencing with a step 1118 in which the thread 1116 waits until the variable time is greater than waitime. Thereafter, in a step 1120, the variable time is set to 0, after which W is calculated in a step 1122. Thereafter in a step 1124 the variable waitime is set equal to W/ρ. Thereafter, in a step 1126 the variable increment is set to 0, after which the thread 1116 is directed back to the step 1118.

The entropy policing process which has been described in relation to FIGS. 8A and 8B, is represented in pseudo-form in the Table 2 hereinafter.

Additional modifications can be made to the processes of FIGS. 7A, 7B, 8A, and 8B in order to minimize the filtering of a traffic source. For example, the online calculation step for the probability function W(x,α) (ie step 510 in FIG. 7B, and step 1122 in FIG. 8B) can be replaced with a pre-determined look-up table defining allowed bucket sizes in a given period of time. In this arrangement, when traffic arrives, the number of packets in a given time unit is checked against this predetermined table, and the smallest, ie minimum allowed bucket size allowing conformance of the traffic, is selected from the table. This allowed bucket size is then removed from the table and is not available for further selection. After a set period has elapsed, the table can be refreshed to its original state. Such optimization techniques can readily be implemented with minor modifications to the aforementioned processes described in FIGS. 7A, 7B, 8A and 8B.

A number of examples are now described in which traffic has been output from an ER characterised by parameters α and ρ. Traffic processed in this manner can be used in calculating overflow probabilities for downstream buffers. Traffic which is output from the ER which enters a downstream buffer having an output rate of ρ has, if plotted on axes of log P vs buffer occupancy, a bound represented by a straight line with slope α on the log P versus buffer occupancy graph (see FIG. 10). It is noted that this is not merely a straight line in the limit of large buffer occupancy, as is the case in large deviation theory. In fact, in terms of QoS, this example allows the end user to know precisely the bounded buffer occupancy spectrum. This is, accordingly, a far more informative situation than that prevailing using Token Bucket Regulators, which provide only a bound on maximum delay experienced by a packet.

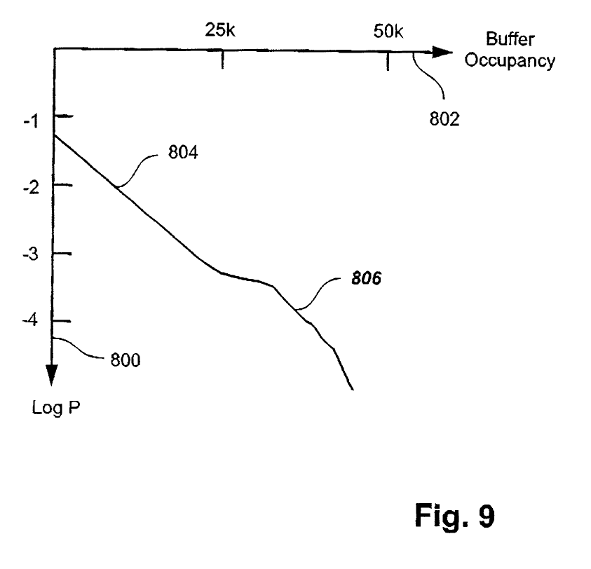

The QoS can be characterized by the slope of the log P vs buffer occupancy graph (eg. see FIGS. 9 and 10). For a given buffer size in a network element, such graphs depict the probability of data loss. Furthermore the spectrum of delay of data successfully carried can also be determined. Knowledge of the bounded buffer occupancy spectrum can be used in various ways. If, for example, only a particular fraction of packets needs to be transmitted through the network with a minimum delay, then less jitter can be imposed at the regulation stage on traffic relative to what would otherwise be required if all packets are to be transmitted with the minimum delay.

FIGS. 9 and 10 show an example of measured TCP data (described in “Wide Area Traffic: The Failure of Poisson Modelling”, V. Paxson and S. Floyd, IEEE/ACM Tran. On Networking, vol. 3 (3), 1995, pp. 226-244) before, and after regulation respectively, the traffic having been passed through a downstream buffer with leak rate ρ. It is noted that the data being considered in this example possesses long-range correlations, and cannot be modelled accurately using a Markov process. FIGS. 9 and 10 illustrate the performance of the entropy regulator in producing traffic having a pre-determined entropy bound.

A case is now considered in which ρ is set equal to a mean of the probability density function g(x) associated with the distribution function F, which is expressed mathematically as follows:

$${ρ}_{m} = {\int }_{0}^{∞} x g ( x ) ⅆ x \qquad ( 17 )$$

The log of the moment generating function Λ(θ) can be determined as follows:

$$Λ ( θ ) = log {\int }_{0}^{∞} {e}^{θ} g ( x ) ⅆ x , \qquad ( 18 )$$

and the effective bandwidth is then given by

$${ρ}_{e} ( θ ) = \frac{Λ ( θ )}{θ} = \frac{1}{θ} log {\int }_{0}^{∞} {e}^{θ} g ( x ) ⅆ x \qquad ( 19 )$$

Making use of a function F as described by Equation (13), the effective bandwidth can then be determined according to the following mathematical representation:

$${ρ}_{e} ( θ ) = \frac{Λ ( θ )}{θ} = - \frac{1}{θ} log ( 1 - \frac{θ}{α} ) , ( θ < α ) \qquad ( 20 )$$

Alternatively, a Gaussian probability density function f(x) may be assumed. In this case, effective bandwidth ρₑ is described as follows:

$${ρ}_{e} ( θ ) = \frac{Λ ( θ )}{θ} = {ρ}_{m} + \frac{θ {α}^{2}}{2} \qquad ( 21 )$$

where in this case, α represents the standard deviation of the Gaussian distribution. If the ρ parameter of the ER is now set to ρₘ and the function F as given by Equation (13) is adopted, then the effective bandwidth ρ_{c} is approximately given by Equation (20). In other words, since incorporation of an ER into a traffic stream results in output traffic which is forced to zero for some predetermined time, the effective bandwidth ρₑ of traffic output from the ER is an approximation of traffic described by Equation (20). This approximation is, however, sufficiently accurate to provide real benefits in actual networks.

In the present example, in considering what amount of bandwidth can be allocated by the network management administrator to a new user who requests a QoS requirement, the relationship in Equation (19) can be used in order to calculate the effective bandwidth ρ_{c}(θ). This desired effective bandwidth can be checked against available bandwidth in the network, and allocated to the new user, or not, according to the available network bandwidth store. This establishes a quantitative connection admission control procedure.

A further example highlights the use of the Entropy Regulator used as a shaper as follows. A user has a 33 kbit/s link to a downstream network node which possesses a FIFO buffer having B bits with an output rate of 33 kbit/s. If the user chooses to specify a QoS parameterized by a slope in the log P vs. buffer occupancy plot of this node equal to 2×10⁻⁴, then the user sets the shaper parameters as α=2×10^{×4} and ρ=33kbit/s.

In this arrangement, regardless of the traffic that the user has transmitted to the network (ie. to the downstream node), the conforming packets result in a bounded buffer occupancy characterized by a slope 2×10⁻⁴ in the log P vs. buffer occupancy plot. The plots of FIG. 9 (before regulation) and FIG. 10 (after regulation) show a simulation of this result. The curve 904 in FIG. 10 is indicative of a probability (represented by the ordinate) with which a particular buffer occupancy (represented by the abscissa) is exceeded. It is desirable to operate at a low probability of overflow, since traffic is lost if a buffer overflows.

Alternatively if the downstream network node has the buffer size of B, but the user chooses to specify a probability P that bits will not be discarded, then the user calculates α from the following mathematical equality:

α=−log(1−P)/B (22)

For example if the buffer size is 8000 bits and the user specifies a “no-loss” probability of 99%, then an a of 5.7×10⁻⁴ is selected.

If the network consists of an ER followed by a network element containing a buffer with output rate ρ_{T}, then the probability of the end-to-end delay spectrum dj for the packet j can be determined as follows:

P{dj≧x}≦e^{-apx} (23)

where (x≧0)

It is noted that transmission and propagation delays experienced by the packet as it traverses the network have been ignored. An aggregation of N sources all with the same QoS requirements (ie. same α) also have the same end-to-end delay spectrum, provided the downward link capacity α_{T} satisfies the following inequality:

$${\sum }_{i = l}^{N} {ρ}_{i} \leq {ρ}_{T} . \qquad ( 24 )$$

More sophisticated uses for the ER can be envisioned. In particular, if per-flow guaranteed-rate scheduling algorithms are deployed in the downstream nodes, then the above equations can be used to determine the delay spectrum for multiple users who are all requesting different QoS specifications.

In order to highlight the efficacy of the Entropy Regulator, in the example above, the ρ parameter of the Entropy Regulator is set to ρ=1/α. The ER then produces a probability density function for the output rate that is, to a close approximation, an exponential distribution with a sustained rate of 3 kbit/s. The effective bandwidth ρₑ=Λ(θ)/θ is then determined to be approximately 4.6 kbit/s in order to obtain a QoS parameterized by θ=10⁻⁴. This result shows an efficiency to be gained by use of the Entropy Regulator arrangement.

It is found that network dimensioning using Equation (19) directly in order to provide the required QoS results in reservation of bandwidth which is approximately 50% higher than the bandwidth required using the arrangement depicted in FIGS. 7A and 7B. Furthermore, the arrangement of FIGS. 7A and 7B nonetheless does provide sufficient bandwidth to provide the required QoS. Accordingly, the disclosed arrangement in FIGS. 7A and 7B effects a bandwidth saving over direct use of the (theoretical) model in Equation (19).

Effective bandwidth analysis can be used for any distribution function F in the arrangements depicted in FIGS. 7A, 7B, 8A and 8B. For ease of illustration in the above discussion however, a function has been used which corresponds to the exponential distribution (per equation (13)).

Summarising the advantages of using the Entropy Regulator instead of a TBR, the equation for the delay spectrum for entropy regulated flow is compared with a similar equation for a flow passed through a Token Bucket Regulator with parameter ρ and σ as follows:

$${d}_{j} \leq \frac{σ}{ρ} \qquad ( 25 )$$

Transmission and propagation delays experienced by the packet as the packet traverses the network have been ignored for this comparison. When the TBR is used instead of the ER, no information is available to the user in regard to the delay spectrum instead, only a deterministic worst case delay can be ascribed to the end-to-end delay of the packet. Furthermore, the output traffic from the TBR cannot, in general, be described by a Markov process, and as such a pre-determined entropy bound cannot be placed on the output traffic. Accordingly, effective bandwidth theory cannot be applied to the output of a TBR in a quantitative fashion.

Another disadvantage of the TBR is that relative to the ER, additional packet delay can be incurred when compared to the ER.

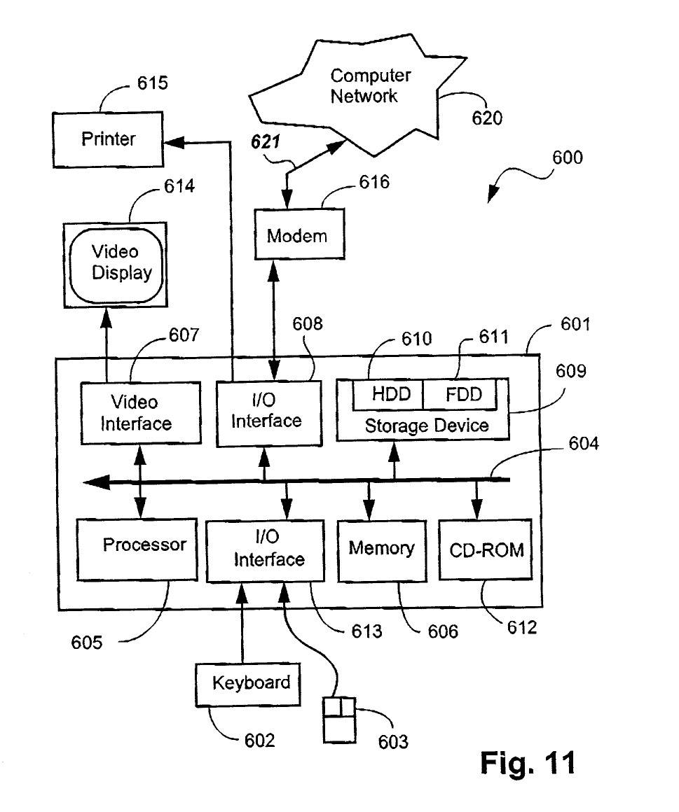

FIG. 11 shows how the method of entropy regulation of packet traffic can be practiced using a conventional general-purpose computer system 600, wherein the processes of FIGS. 7A, 7B, 8A and 8B may be implemented as software, such as an application program executing within the computer system 600. In particular, the process steps relating to the method of entropy regulation of packet traffic are effected by instructions in the software that are carried out by the computer. The software may be divided into two separate parts, one part for carrying out the entropy regulation of packet traffic, and another part to manage the user interface between the latter and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for entropy regulation of packet traffic in accordance with the arrangement described.

The computer system 600 comprises a computer module 601, input devices such as a keyboard 602 and mouse 603, output devices including a printer 615 and a display device 614. A Modulator-Demodulator (Modem) transceiver device 616 is used by the computer module 601 for communicating to and from a communications network 620, for example connectable via a telephone line 621 or other functional medium. The modem 616 can be used to obtain access to the Internet, and other network systems, such as a Local Area Network (LAN) or a Wide Area Network (WAN).

The computer module 601 typically includes at least one processor unit 605, a memory unit 606, for example formed from semiconductor random access memory (RAM) and read only memory (ROM), input/output (I/O) interfaces including a video interface 607, and an I/O interface 613 for the keyboard 602 and mouse 603 and optionally a joystick (not illustrated), and an interface 608 for the modem 616. A storage device 609 is provided and typically includes a hard disk drive 610 and a floppy disk drive 611. A magnetic tape drive (not illustrated) may also be used. A CD-ROM drive 612 is typically provided as a non-volatile source of data The components 605 to 613 of the computer module 601, typically communicate via an interconnected bus 604 and in a manner which results in a conventional mode of operation of the computer system 600 known to those in the relevant art. Examples of computers on which the embodiments can be practised include IBM-PC's and compatibles, Sun Sparcstations or alike computer systems evolved therefrom.

Typically, the application program of the embodiment is resident on the hard disk drive 610 and read and controlled in its execution by the processor 605. Intermediate storage of the program and any data fetched from the network 620 may be accomplished using the semiconductor memory 606, possibly in concert with the hard disk drive 610. In some instances, the application program may be supplied to the user encoded on a CD-ROM or floppy disk and read via the corresponding drive 612 or 611, or alternatively may be read by the user from the network 620 via the modem device 616. Still further, the software can also be loaded into the computer system 600 from other computer readable medium including magnetic tape, a ROM or integrated circuit, a magneto-optical disk, a radio or infra-red transmission channel between the computer module 601 and another device, a computer readable card such as a PCMCIA card, and the Internet and Intranets including email transmissions and information recorded on websites and the like. The foregoing is merely exemplary of relevant computer readable mediums. Other computer readable mediums may be practiced without departing from the scope and spirit of the invention.

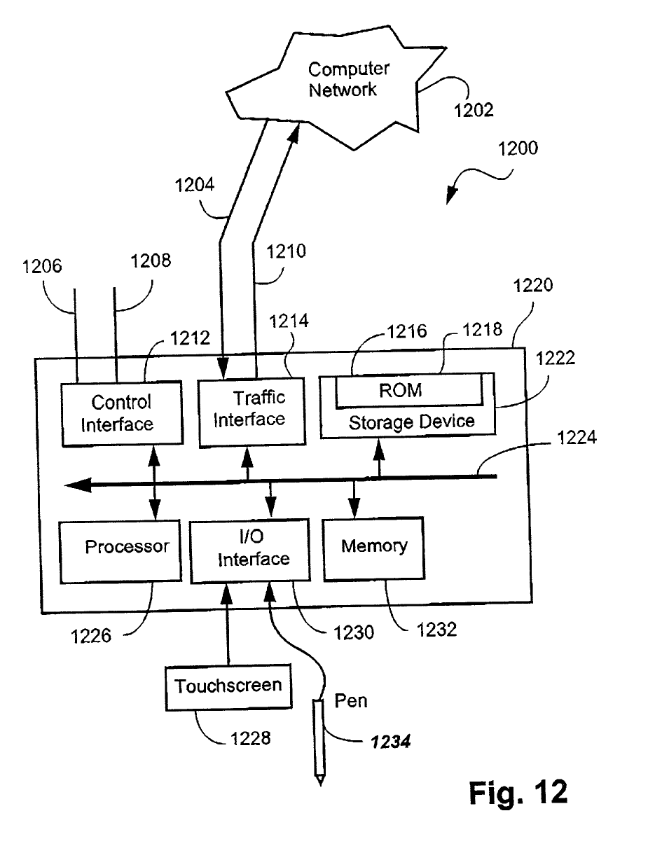

FIG. 12 shows how the method of entropy regulation of packet traffic can be practiced using a special-purpose processor system 1200, wherein the processes of FIGS. 7A, 7B, 8A and 8B may be implemented as software, such as an application program executing within me computer system 1200. In particular, the process steps relating to the method of entropy regulation of packet traffic are effected by instructions in the software that are carried out by the processor. The software may be divided into two separate parts, one part for carrying out the entropy regulation of packet traffic, and another part to manage the user interface between the latter and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for entropy regulation of packet traffic in accordance with the arrangement described.

The processor system 1200 comprises a computer module 1220, input devices such as a touchscreen 1228 and pen 1234, and a display device comprising the touchscreen 1228. A traffic interface 1214 is used by the processor module 1220 for receiving one or more traffic streams depicted by an arrow 1204, and for transmitting an output traffic stream depicted by an arrow 1210 respectively from and to a communications network 1202. The output traffic stream depicted by the arrow 1210 is subject to imposition of a pre-determined entropy bound. The traffic interface 1214 can be used to obtain access to the Internet, and other network systems, such as a Local Area Network (LAN) or a Wide Area Network (WAN).

The processor module 1220 typically includes at least one processor unit 1226, a memory unit 1232, for example formed from semiconductor random access memory (RAM) and read only memory (ROM), an I/O interface 1230 for the touchscreen 1228 and pen 1234, and the traffic interface 1214. A storage device 1222 is provided and typically includes a Read Only Memory (ROM) memory module 1218. A further I/O interface 1212 is provided to permit input of the input parameters, namely the probability slope parameter α, which is input on a line 1206, and the mean output rate parameter ρ which is input on a line 1208. The components 1212, 1214, 1218, 1226 and 1230 of the processor module 1220 typically communicate via an interconnected bus 1224 and in a manner which results in a conventional mode of operation of the processor system 1220 known to those in the relevant art. Examples of processor systems on which the arrangements can be practiced include network cards and Java™ virtual machines.

Typically, the application program of the arrangement is resident in the memory 1232, and read and controlled in its execution by the processor 1226. Intermediate storage of the program, as well as packet traffic to be regulated fetched from the network 1202 may be accomplished using the storage device 1222. In some instances, the application program may be supplied to the user encoded on the flashcard 1218, or alternatively may be read by the processor module 1220 from the network 1202 via a modem device (not shown). Still further, the software can also be loaded into the processor system 1220 from other computer readable medium (not shown) including magnetic tape, a ROM or integrated circuit, a magneto-optical disk, a radio or infra-red is transmission channel between the processor module 1220 and another device, a computer readable card such as a PCMCIA card, and the Internet and Intranets including email transmissions and information recorded on websites and the like. The foregoing is merely exemplary of relevant computer readable mediums. Other computer readable mediums may be practiced without departing from the scope and spirit of the invention.

The method of entropy regulation of packet traffic may, alternatively, be implemented in dedicated hardware such as one or more integrated circuits performing the functions or sub functions of entropy regulation of packet traffic. Such dedicated hardware may include graphic processors, digital signal processors, or one or more microprocessors and associated memories.

### Industrial Applicability

It is apparent from the above that the embodiment of the invention is applicable to the telecommunications and computer network industries.

The foregoing describes only some embodiments of the present invention, and modifications and/or changes can be made thereto without departing from the scope and spirit of the invention, the embodiments being illustrative and not restrictive.

For example, the entropy regulator can be used in active programmable networks, where feedback mechanisms allow end users to adjust entropy regulation parameters in real-time in order to achieve a desired quality of service. The network will, in these cases, respond dynamically, using effective bandwidth processes to determine, and allocate, the appropriate network resources, thereby allocating differential bandwidth as required by a difference between a present and a target bandwidth.

The entropy regulator could also be used as a behavioural aggregate traffic conditioner at the edge of a Diffserv Domain, (see Internet Engineering Task Force (IETF) documents RFC 2474, RFC 2475, RFC2597 and RFC 2598). Although the detailed use of the ER in the Diffserv context would differ somewhat from the ATM-Call Admission Control set-up, the underlying principal use of the ER would be the same.

The ER approach can be applied equally to networks carrying fixed length packets such as those found in ATM networks, and variable length packets such as those found in Internet Protocol (IP) networks.

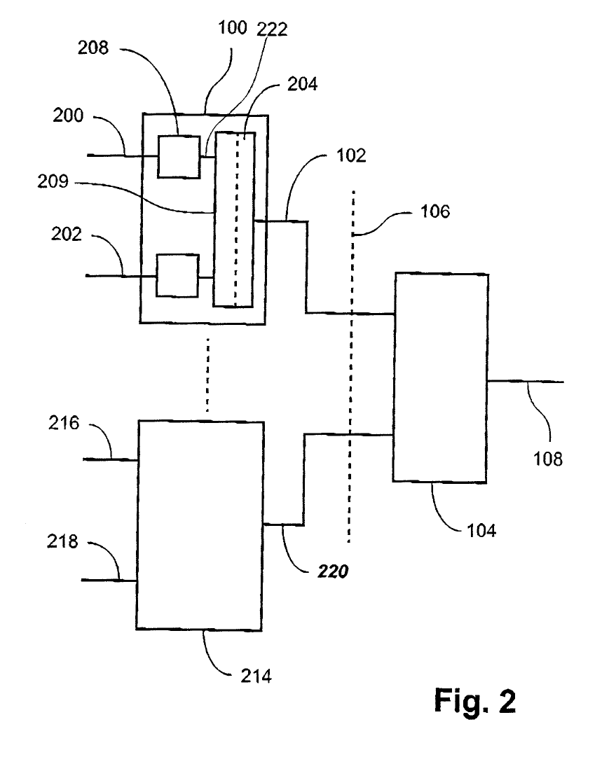

For ease of illustration the ER as described has been used in conjunction with a simple FIFO scheduling mechanism 209 (see FIG. 2). This type of scheduling can accommodate the QoS requirements of individual flows provided all flows have been regulated using the same QoS parameters. In the case where flows with differing QoS requirements are aggregated, the multiplexer, and other downstream network nodes, have to deploy more advanced scheduling algorithms, such as Weighted Fair Queuing. However, the use and operation of the Entropy Regulator remains the same as described.

TABLE 2
Pseudo Code For Shaper Mode

define global variables buffer, W, conformTime, TOT, alpha, rho, rateViolation, time,
waitime,
[time=waitime=0, initially];
Commence synchronized Thread 1
Thread 1
{
define local variables Li, Ti;
label 10

IF packet arrives {
set Li=packet length;
set Ti=packet arrival time;

IF (first packet) {call output(Li) ; set conformTime=Ti; set TOT=Li;}
ELSE IF( buffer>0) call addToBuffer(Li);
ELSE{

call checkRate(Li, Ti);
IF (rateViolation==TRUE) call addToBuffer(Li);
ELSE { call output(Li) ; set conform Time=Ti;}

}

}

GOTO label 10;
}
Thread 2
{
label 20
WHILE(time<waitime) let clock increase time and wait;

IF (time>=waitime and buffer>0){

set time=0
call setW();
IF(buffer>W) call setOutput_1();
ELSE call setOutput_2();

}
GOTO label 20;

}
function setOutput_1() {
define local variable L1;
//note: i=1 represents the packet that has been in buffer longest
// and L1 represents length of that packet
IF(L1>W){
set waitime=L1/rho;
set conformTime=current time+L1/rho;
}
ELSE{

WHILE(TOT<W){

Do (from i=1, incrementing i by 1 at each step) TOT=TOT+length of packet i;
//note; TOT is not incremented if above leads to TOT>W

}

call output(TOT);
set conformTime=current time;
set waitime=TOT/rho;
}
function setOutput_2(){
set TOT=buffer;
call output(TOT);
set conformTime=current time;
set waitime=TOT/rho;
}
function output(n_out){
output n_out bits from network element onto output wire
set buffer=maximum[0,buffer-n_out];
}
function addToBuffer(n_in){
add n_{—in bits to the shaping buffer;}
set buffer=buffer+n_{—in;}
IF first time a packet has been added commence synchronized Thread 2;
}
function setW(){
define local variable x;
set x=random number generator output [between 0 and 1];
set W = (1/alpha) log[1/(1−x)];
}
function checkRate(Li,Ti){
define local variable R;
R=(Li+TOT)/(Ti−conformTime);
IF (R>rho) rateViolation==TRUE;
ELSE rateViolation==FALSE;
}

Pseudo Code For Policer Mode

define global variables increment, W;
Commence synchronized Threads 1 and 2
Thread 1 {
define local variables alpha, rho, time, waitime [time=waitime=0,
initially];
label 10
WHILE(time<waitime) let clock increase time and wait;

IF (time>=waitime){

set time=0;
call setW(alpha);
set waitime=W/rho;
set increment=0;

}
GOTO label 10;
function setW(alpha){

define local variable x;
set x=random number generator output [between 0 and 1];
set W = (1/alpha) log[1/(1−x)];

}

}
Thread 2 {
define local variable Li;
label 20

IF packet arrives{

set Li= length of packet;
set increment=increment+Li;
IF (increment>W) mark packet non-conforming;
ELSE mark packet conforming;

}
GOTO label 20;

}

1. A method of shaping input packet traffic, said method comprising steps of:
determining a constraint parameter dependent upon a probability density function; and
constraining, based upon said parameter, transmission of the input packet traffic, thereby to produce output packet traffic having a pre-determined entropy bound.

2. A method according to claim 1, wherein prior to the determining step, the method comprises a further step of:
selecting a type of the probability density function.

3. A method according to claim 2, wherein a probability distribution function which is derived from the probability density function of the selected type is evaluated in conjunction with the determining step, thereby permitting said determining of the constraint parameter.

4. A method according to claim 2, wherein a probability distribution function which is derived from the probability density function of the selected type is evaluated prior to the determining step, thereby permitting said determining of the constraint parameter.

5. A method according to claim 4, wherein the evaluated probability distribution function is arranged as a look-up table of constraint parameter values, and wherein the determining step comprises sub-steps of:
selecting, from the look-up table, a smallest one of said constraint parameter values which matches a characteristic of the input packet traffic; and
deleting said smallest constraint parameter value from the look-up table.

6. A method according to claim 5, wherein the look-up table is refreshed to an original state after a time period.

7. A method according to claim 1, wherein the probability density function is an exponential function.

8. A packet traffic shaper comprising:
determination means configured to determine a constraint parameter dependent upon a probability density function; and
constraining means configured to constrain, based upon the parameter, transmission of traffic input to said constraining means, thereby to produce output traffic having a pre-determined entropy bound.

9. A packet traffic shaper according to claim 8, further comprising:
selection means configured to select a type of the probability density function.

10. A packet traffic shaper according to claim 9, further comprising:
derivation means configured to derive a probability distribution function from the probability density function of the selected type, said derivation being performed in conjunction with determining the constraint parameter.

11. A packet traffic shaper according to claim 9, further comprising:
derivation means configured to derive a probability distribution function from the probability density function of the selected type, said derivation being performed prior to determining the constraint parameter.

12. A packet traffic shaper according to claim 11, wherein the derived probability distribution function is arranged as a look-up table of constraint parameter values, and wherein the determination means comprise:
selecting means configured to select, from the look-up table, a smallest one of said constraint parameter values which matches a characteristic of the input packet traffic; and
deleting means configured to delete said smallest constraint parameter value from the look-up table.

13. A packet traffic shaper according to claim 12, further comprising:
refresh means configured to refresh the look-up table to an original state after a time period.

14. A packet traffic shaper according to claim 8, wherein the probability density function is an exponential function.

15. A computer readable memory medium for storing a program for an apparatus which shapes input packet traffic, said program comprising:
code for a determining step for determining a constraint parameter dependent upon a probability density function; and
code for a constraining step for constraining, based upon said parameter, transmission of the input packet traffic, thereby to produce output packet traffic having a pre-determined entropy bound.

16. A computer readable memory medium according to claim 15, further comprising code for a selecting step for selecting a type of the probability density function.

17. A computer readable memory medium according to claim 16, further comprising:
code for a deriving step for deriving a probability distribution function from the probability density function of the selected type, said derivation being performed in conjunction determining the constraint parameter.

18. A computer readable memory medium according to claim 16, further comprising:
code for a deriving step for deriving a probability distribution function from the probability density function of the selected type, said derivation being performed prior to determining the constraint parameter.

19. A computer readable memory medium according to claim 18, wherein the derived probability distribution function is arranged as a look-up table of constraint parameter values, and wherein the code for the determining step comprises:
code for a selecting step for selecting, from the look-up table, a smallest one of said constraint parameter values which matches a characteristic of the input packet traffic; and
code for a deleting step for deleting said smallest constraint parameter value from the look-up table.

20. A computer readable memory medium according to claim 19, further comprising:
code for a refresh step for refreshing the look-up table to an original state after a time period.

21. A computer readable memory medium according to claim 15, wherein the probability density function is an exponential function.

22. A computer program for an apparatus which shapes input packet traffic, said program comprising:
code for a determining step for determining a constraint parameter dependent upon a probability density function; and
code for a constraining step for constraining, based upon said parameter, transmission of the input packet traffic, thereby to produce output packet traffic having a pre-determined entropy bound.

23. A computer program according to claim 22, further comprising code for a selecting step for selecting a type of the probability density function.

24. A computer program according to claim 23, further comprising:
code for a deriving step for deriving a probability distribution function from the probability density function of the selected type, said derivation being performed in conjunction determining the constraint parameter.

25. A computer program according to claim 23, further comprising:
code for a deriving step for deriving a probability distribution function from the probability density function of the selected type, said derivation being performed prior to determining the constraint parameter.

26. A computer program according to claim 25, wherein the derived probability distribution function is arranged as a look-up table of constraint parameter values, and wherein the code for the determining step comprises:
code for a selecting step for selecting, from the look-up table, a smallest one of said constraint parameter values which matches a characteristic of the input packet traffic; and
code for a deleting step for deleting said smallest constraint parameter value from the look-up table.

27. A computer program according to claim 26, further comprising:
code for a refresh step for refreshing the look-up table to an original state after a time period.

28. A computer program according to claim 22, wherein the probability density function is an exponential function.

29. A method of policing input packet traffic, said method comprising steps of:
determining a constraint parameter dependent upon a probability density function; and
tagging, based upon said parameter, conforming packets in the input packet traffic, thereby to produce output packet traffic wherein tagged packets comprise a policed traffic stream having a predetermined entropy bound.

30. A method according to claim 29, wherein prior to the determining step, the method comprises a further step of:
selecting a type of the probability density function.

31. A method according to claim 30, wherein a probability distribution function which is derived from the probability density function of the selected type is evaluated in conjunction with the determining step, thereby permitting said determining of the constraint parameter.

32. A method according to claim 30, wherein a probability distribution function which is derived from the probability density function of the selected type is evaluated prior to the determining step, thereby permitting said determining of the constraint parameter.

33. A method according to claim 32, wherein the evaluated probability distribution function is arranged as a look-up table of constraint parameter values, and wherein the determining step comprises sub-steps of:
selecting, from the look-up table, a smallest one of said constraint parameter values which matches a characteristic of the input packet traffic; and
deleting said smallest constraint parameter value from the look-up table.

34. A method according to claim 33, wherein the look-up table is refreshed to an original state after a time period.

35. A method according to claim 29, wherein the probability density function is an exponential function.

36. A packet traffic policer comprising:
determination means configured to determine a constraint parameter dependent upon a probability density function; and
tagging means configured to tag, based upon the parameter, conforming packets in traffic input to said tagging means, thereby to produce output traffic wherein tagged packets comprise a policed traffic stream having a predetermined entropy bound.

37. A packet traffic policer according to claim 36, further comprising:
selection means for selecting a type of the probability density function.

38. A packet traffic policer according to claim 37, further comprising:
derivation means configured to derive a probability distribution function from the probability density function of the selected type, said derivation being performed in conjunction with said determining of the constraint parameter.

39. A packet traffic policer according to claim 37, further comprising:
derivation means configured to derive a probability distribution function from the probability density function of the selected type, said derivation being performed prior to said determining of the constraint parameter.

40. A packet traffic policer according to claim 39, wherein the evaluated probability distribution function is arranged as a look-up table of constraint parameter values, and wherein the determining means comprise:
selecting means configured to select from the look-up table, a smallest one of said constraint parameter values which matches a characteristic of the input packet traffic; and
deleting means configured to delete said smallest constraint parameter value from the look-up table.

41. A packet traffic policer according to claim 40, further comprising:
refresh means configured to refresh the look-up table to an original state after a time period.

42. A packet traffic policer according to claim 36, wherein the probability density function is an exponential function.

43. A computer readable memory medium for storing a program for an apparatus which polices input packet traffic, said program comprising:
code for a determining step for determining a constraint parameter dependent upon a probability density function; and
code for a tagging step for tagging, based upon said parameter, conforming packets in the input packet traffic, thereby to produce output packet traffic wherein tagged packets comprise a policed traffic stream having a predetermined entropy bound.

44. A computer readable memory medium according to claim 43, further comprising code for a selecting step for selecting a type of the probability density function.

45. A computer readable memory medium according to claim 44, further comprising:
code for a deriving step for deriving a probability distribution function from the probability density function of the selected type, said derivation being performed in conjunction with said determining of the constraint parameter.

46. A computer readable memory medium according to claim 44, further comprising:
code for a deriving step for deriving a probability distribution function from the probability density function of the selected type, said derivation being performed prior to said determining of the constraint parameter.

47. A computer readable memory medium according to claim 46, wherein the evaluated probability distribution function is arranged as a look-up table of constraint parameter values, and wherein the code for the determining step comprises:
code for a selecting step for selecting, from the look-up table, a smallest one of said constraint parameter values which matches a characteristic of the input packet traffic; and
code for a deleting step for deleting said smallest constraint parameter value from the look-up table.

48. A computer readable memory medium according to claim 47, further comprising:
code for a refresh step for refreshing the look-up table to an original state after a time period.

49. A computer readable memory medium according to claim 43, wherein the probability density function is an exponential function.

50. A computer program for an apparatus which polices input packet traffic, said program comprising:
code for a determining step for determining a constraint parameter dependent upon a probability density function; and
code for a tagging step for tagging, based upon said parameter, conforming packets in the input packet traffic, thereby to produce output packet traffic wherein tagged packets comprise a policed traffic stream having a pre-determined entropy bound.

51. A computer program according to claim 50, further comprising code for a selecting step for selecting a type of the probability density function.

52. A computer program according to claim 51, further comprising:
code for a deriving step for deriving a probability distribution function from the probability density function of the selected type, said derivation being performed in conjunction with said determining of the constraint parameter.

53. A computer program according to claim 51, further comprising:
code for a deriving step for deriving a probability distribution function from the probability density function of the selected type, said derivation being performed prior to said determining of the constraint parameter.

54. A computer program according to claim 53, wherein the evaluated probability distribution function is arranged as a look-up table of constraint parameter values, and wherein the code for the determining step comprises:
code for a selecting step for selecting, from the look-up table, a smallest one of said constraint parameter values which matches a characteristic of the input packet traffic; and
code for a deleting step for deleting said smallest constraint parameter value from the look-up table.

55. A computer program according to claim 54, further comprising:
code for a refresh step for refreshing the look-up table to an original state after a time period.

56. A computer program according to claim 50, wherein the probability density function is an exponential function.

57. A method of controlling admission of a proposed additional input packet traffic stream to a network node, said node having a prior input packet traffic stream, and an output packet traffic stream carried on a link having an associated maximum bandwidth, said method comprising steps of:
shaping the prior input packet traffic stream to have a corresponding pre-determined entropy bound if said prior stream does not have said corresponding pre-determined entropy bound;
shaping the proposed additional input packet traffic stream to have a corresponding pre-determined entropy bound if said proposed stream does not have said corresponding pre-determined entropy bound;
determining corresponding equivalent bandwidths for the prior traffic stream and the proposed additional traffic stream; and
admitting the proposed additional traffic stream if a sum of the corresponding equivalent bandwidths of the prior traffic stream and the proposed additional traffic stream does not exceed said maximum bandwidth.

58. A connection admission controller configured to control admission of a proposed additional input packet traffic stream to a network node, said node having a prior input packet traffic stream, and an output packet traffic stream carried on a link having an associated maximum bandwidth, said controller comprising:
first shaping means configured to shape the prior input packet traffic stream to have a corresponding predetermined entropy bound if said prior stream does not have said corresponding pre-determined entropy bound;
second shaping means configured to shape the proposed additional input packet traffic stream to have a corresponding predetermined entropy bound if said proposed stream does not have said corresponding pre-determined entropy bound;
determining means configured to determine corresponding equivalent bandwidths for the prior traffic stream and the proposed additional traffic stream; and
admission means configured to admit the proposed additional traffic stream if a sum of the corresponding equivalent bandwidths of the prior traffic stream and the proposed additional traffic stream does not exceed said maximum bandwidth.

59. A computer readable memory medium for storing a program for an apparatus which controls admission of a proposed additional input packet traffic stream to a network node, said node having a prior input packet traffic stream, and an output packet traffic stream carried on a link having an associated maximum bandwidth, said program comprising:
code for a first shaping step for shaping the prior input packet traffic stream to have a corresponding pre-determined entropy bound if said prior stream does not have said corresponding predetermined entropy bound;
code for a second shaping step for shaping the proposed additional input packet traffic stream to have a corresponding pre-determined entropy bound if said proposed stream does not have said corresponding pre-determined entropy bound;
code for a determining step for determining corresponding equivalent bandwidths for the prior traffic stream and the proposed additional traffic stream; and
code for an admitting step for admitting the proposed additional traffic stream if a sum of the corresponding equivalent bandwidths of the prior traffic stream and the proposed additional traffic stream does not exceed said maximum bandwidth.

60. A computer program for an apparatus which controls admission of a proposed additional input packet traffic stream to a network node, said node having a prior input packet traffic stream, and an output packet traffic stream carried on a link having an associated maximum bandwidth, said program comprising:
code for a first shaping step for shaping the prior input packet traffic stream to have a corresponding pre-determined entropy bound if said prior stream does not have said corresponding pre-determined entropy bound;
code for a second shaping step for shaping the proposed additional input packet traffic stream to have a corresponding pre-determined entropy bound if said proposed stream does not have said corresponding pre-determined entropy bound;
code for a determining step for determining corresponding equivalent bandwidths for the prior traffic stream and the proposed additional traffic stream; and
code for an admitting step for admitting the proposed additional traffic stream if a sum of the corresponding equivalent bandwidths of the prior traffic stream and the proposed additional traffic steam does not exceed said maximum bandwidth.

61. A method of adjusting a present bandwidth allocated to a packet traffic stream to thereby achieve a desired quality of service, said method comprising steps of:
determining a target equivalent bandwidth required by said traffic stream to meet said desired quality of service;
determining a differential bandwidth dependent upon the present bandwidth and the target equivalent bandwidth;
determining, based upon said differential bandwidth, a probability distribution function; and
constraining, based upon said probability distribution function, transmission of the packet traffic stream, thereby (i) producing an output packet traffic having a pre-determined entropy bound, (ii) allocating to the input traffic stream said target equivalent bandwidth and (iii) achieving said desired quality of service.

62. An apparatus configured to adjust a present bandwidth allocated to a packet traffic stream to thereby achieve a desired quality of service, said apparatus comprising:
first determining means configured to determine a target equivalent bandwidth required by said traffic stream to meet said desired quality of service;
second determining means configured to determine a differential bandwidth dependent upon the present bandwidth and the target equivalent bandwidth;
third determining means configured to determine, based upon said differential bandwidth, a probability distribution function; and
constraining means configured to constrain, based upon said probability distribution function, transmission of the packet traffic stream, thereby (i) producing an output packet traffic having a pre-determined entropy bound, (ii) allocating to the input traffic stream said target equivalent bandwidth and (iii) achieving said desired quality of service.

63. A computer readable memory medium for storing a program for an apparatus configured to adjust a present bandwidth allocated to a packet traffic stream to thereby achieve a desired quality of service, said program comprising;
code for a first determining step for determining a target equivalent bandwidth required by said traffic stream to meet said desired quality of service;
code for a second determining step for determining a differential bandwidth dependent upon the present bandwidth and the target equivalent bandwidth;
code for a third determining step for determining, based upon said differential bandwidth, a probability distribution function; and
code for a constraining step for constraining, based upon said probability distribution function, transmission of the packet traffic stream, thereby (i) producing an output packet traffic having a pre-determined entropy bound, (ii) allocating to the input traffic stream said target equivalent bandwidth and (iii) achieving said desired quality of service.

64. A computer program for an apparatus configured to adjust a present bandwidth allocated to a packet traffic stream to thereby achieve a desired quality of service, said program comprising:
code for a first determining step for determining a target equivalent bandwidth required by said traffic stream to meet said desired quality of service;
code for a second determining step for determining a differential bandwidth dependent upon the present bandwidth and the target equivalent bandwidth;
code for a third determining step for determining, based upon said differential bandwidth, a probability distribution function; and
code for a constraining step for constraining, based upon said probability distribution function, transmission of the packet traffic stream, thereby (i) producing an output packet traffic having a pre-determined entropy bound, (ii) allocating to the input traffic stream said target equivalent bandwidth and (iii) achieving said desired quality of service.
